(19) United States
(12) Patent Application Publication
(10) Pub. No.: US 2017/0023047 A1
(43) Pub. Date: Jan. 26, 2017

(54) TORSION COTTER PIN AND METHOD OF USE

(71) Applicant: Daniel F. Primeau, Clarence, NY (US)

(72) Inventor: Daniel F. Primeau, Clarence, NY (US)

(21) Appl. No.: 14/808,530

(22) Filed: Jul. 24, 2015

(51) Int. Cl. F16B 39/04; F16B 19/00

(52) U.S. Cl. CPC F16B 39/04; F16B 19/004

(57) ABSTRACT

A torsional fastening assembly provides a pin that leverages torque from a torsion spring and a pair of deviated free ends to fix a slotted nut in a locked threaded position. The pin includes a torsion spring that diverges into a pair of legs having free ends. A first free end includes a hump, while a second free end includes a generally 90° bend. The torsion spring exerts a torsional force on the pin that biases the pair of legs to diverge. The legs pass through a slotted nut and a threaded bolt. The hump and the generally 90° bend are engaged around the respective threads of the slotted nut and the bolt, such that the slotted nut is restricted from rotating relative to the bolt. The pin is fabricated from stainless steel to enhance tensile strength and inhibit rust. A cap conceals the pin and the slotted nut.

### CROSS REFERENCE OF RELATED APPLICATIONS

This application claims the benefits of U.S. provisional application No. 62/029,840, filed Jul. 28, 2014 and entitled TORSION COTTER PIN AND METHOD OF USE, which provisional application is incorporated by reference herein in its entirety.

### FIELD OF THE INVENTION

The present invention relates generally to a torsional fastening assembly. More so, the present invention relates to a torsional fastening assembly that provides a pin that leverages a torque from a torsion spring and a pair of deviated free ends to fix a slotted nut in a locked threaded position, wherein the pin is disposed within a perimeter of the slotted nut, such that a cap can cover both the pin and the slotted nut, and wherein the pin is fabricated form stainless steel to inhibit rust and corrosion.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is known that a cotter pin is a half-round wires that are folded over themselves with a loop at one end, which creates a head. The cotter pin is configured to anchor a nut into a fixed position relative to a bolt by insertion through a drilled hole in the bolt. The ends of the cotter pin may then be spread to hold the nut into position.

It is also known that torsion is the twisting of an object due to an applied torque. In sections perpendicular to the torque axis, the resultant shear stress in this section is perpendicular to the radius. A mechanism, such as a wound coil or spring generates torque in the opposite direction in which it is wound. Thus, the free ends of a cotter pin are generally susceptible to deforming under the stress of torsional forces.

Generally, the cotter pin has been traditionally used in conjunction with either a slotted hex nut or castle nut. The cotter pin's main function is to prevent a slotted hex nut or castle nut from unthreading itself from a threaded shank or bolt. The cotter pin is one piece metal wire bent approximately in half leaving one side with two open end tangs and the other a more rounded head.

The cotter pin is inserted along one of the slots of the slotted hex nut or castle nut with the open tang end, through a hole in the threaded shank, until it extends through the hole to the opposing slot in the nut. The cotter pin can be placed in a variety of positions within the hole as long as there is a sufficient portion of the pin on the open tang to be bent. The two open tangs are traditionally bent at least a 90° bend in opposite directions.

With the cotter pin sitting inside two opposing slots and a hole in the shank, the nut is prevented from unthreading itself because the cotter pin is held in place since the bent tangs prevent movement from one side and the rounded end of the opposing side also does not allow the pin to pass through the opening in the threaded shank.

The cotter pin's removal could only come from being sheared off or physically removed by applying pressure to resize the rounded heads within the diameter of the opening and simultaneously pull the cotter pin from its position within the threaded shank. Generally, this application of the cotter pin has been most prevalent in the automotive industry, both for vehicle, truck, and commercial equipment and such.

In many instances, the cotter pin is fabricated from carbon steel. Carbon steel is not as dense an alloy as stainless steel, and thus does not provide tensile and sheer strength needed in most applications. It is also known that cotter pins are not aesthetically pleasing because the free ends protrude from the hole in the shank which it makes it difficult to cap the nut without interference of the pin.

Other proposals have involved cotter pins. The problem with these fastening mechanisms is that they do not provide sufficient torsion for retaining the nut in place. The traditional cotter pins also require shearing to remove. The cotter pins also are not pleasing to view because of the free legs that protrude therefrom. Also, the carbon steel fabrication has a proclivity to rust and corrode. Even though the above cited fasteners and cotter pins meet some of the needs of the market, a stainless steel torsional fastening assembly that leverages torque from a torsion spring and has a pair of deviated free ends to fix a slotted nut in a locked threaded position, while also concealing the free ends and the slotted nut is still desired.

### SUMMARY OF THE INVENTION

The present invention is directed to a torsional fastening assembly. The torsional fastening assembly comprises at least one of a pin, a slotted nut, a bolt, and a cap. The pin comprises a torsion spring, which leverages torque that is generated from being wound. The pin further comprises a pair of deviated free ends to engage and fix a slotted nut in a locked threaded position. The legs are pressed against the threaded region of the slotted nut and the bolt through the torsional force generated by the torsion spring.

In some embodiments, the pin may include a torsion spring that diverges into a pair of legs having free ends. A first free end includes a hump, while a second free end includes a generally 90° bend. The torsion spring exerts a torsional force on the pin in an opposite direction in which the torsion spring is wound. The torsional force biases the pair of legs to diverge at the free ends. The pin is fabricated from stainless steel, so as to exert greater torsion, enhance tensile and shear strength, and inhibit rust and corrosion.

In some embodiments, the pin may work in conjunction with a slotted nut and a bolt to prevent the slotted nut from unthreading itself from the bolt. The slotted nut is defined by a male end having a plurality of slots. The slots are configured to enable passage of the pin across the slotted nut for passing through a hole in the bolt. The slots have a slot outer thread and a slot inner thread. The slotted nut is further defined by a female end having a threaded inner surface. The bolt is defined by an outer threaded surface that is configured to rotatably mate with the threaded inner surface of the slotted nut.

In operation, the bolt is threaded through the slotted nut to a desired threaded position. Once the desired threaded position has been achieved, the pair of free legs from the pin are pressed together and pass through the hole in the bolt. The first free end having the hump engages an outer threaded surface of the bolt. The generally curved shape of the hump partially wraps around the circumference of the outer threaded surface of the bolt, helping to restrict rotation of the bolt inside the slotted nut. The generally 90° bend on the second free end wedges between the outer threaded surface of the bolt and a threaded inner surface of the slotted nut to further restrict rotation of the slotted nut relative to the bolt.

Once fully engaged, the pin is disposed within a perimeter of the slotted nut, such that a cap can cover both the pin and the slotted nut. The cap is defined by a closed end and an open end having a threaded opening. The threaded opening of the cap rotatably mates with the slot outer thread of the slotted nut. In this manner, both the free ends of the pin and the slotted nut may be concealed.

It is one objective of the present invention to provide a pin that restrict rotation of the bolt inside the slotted nut.

It is another objective to provide a pin fabricated from stainless steel, so as to exert greater torsion, enhance tensile and shear strength, and inhibit rust.

It is another objective to provide a hump on a first free end of the legs to help restrict rotation of the slotted nut relative to the bolt.

Yet another objective is to provide a generally 90° bend on a second free end of the legs to wedge between the outer threaded surface of the bolt and a threaded inner surface of the slotted nut to further restrict rotation of the slotted nut relative to the bolt.

It is another objective to provide a fastening pin with a torsion spring that presses the hump and the generally 90° bend on the free ends of the legs against the respective threads of the slotted nut and the bolt.

Yet another objective is to provide an inexpensive to manufacture torsional fastening assembly that is also easy to use with a slotted nut and a bolt.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a top left view of an exemplary pin, in accordance with an embodiment of the present invention;

FIG. 2 illustrates a top right view of the pin, in accordance with an embodiment of the present invention;

FIG. 3 illustrates an elevated left side view of the pin, in accordance with an embodiment of the present invention;

FIG. 4 illustrates an elevated right side view of the pin, in accordance with an embodiment of the present invention;

FIG. 5 illustrates a right perspective view of the pin, in accordance with an embodiment of the present invention;

FIG. 6 illustrates a left perspective view of the pin, in accordance with an embodiment of the present invention;

FIG. 7 illustrates an end view of a torsion spring, in accordance with an embodiment of the present invention;

FIG. 8 illustrates an end view of a pair of free ends, in accordance with an embodiment of the present invention;

FIG. 9 illustrates a top view of an exemplary slotted nut, in accordance with an embodiment of the present invention;

FIG. 10 illustrates a top view of the slotted nut, in accordance with an embodiment of the present invention;

FIG. 11 illustrates a right side sectioned side view of the slotted nut in accordance with an embodiment of the present invention;

FIG. 12 illustrates a right side sectioned side view of the slotted nut, in accordance with an embodiment of the present invention;

FIG. 13 illustrates a side sectioned side view of the slotted nut, the section taken along section A-A of FIG. 10, detailing a plurality of slots, in accordance with an embodiment of the present invention;

FIG. 14 illustrates a top angle perspective view of the pin, the slotted nut, and an exemplary cap, in accordance with an embodiment of the present invention;

FIG. 15 illustrates a bottom angle perspective view of the pin, the slotted nut, and the cap, in accordance with an embodiment of the present invention;

FIG. 16 illustrates a sectioned left side view of the pin engaged with the slotted nut and an exemplary bolt, in accordance with an embodiment of the present invention;

FIG. 17 illustrates a sectioned right side view of the pin, the slotted nut and the bolt, in accordance with an embodiment of the present invention;

FIG. 18 illustrates a sectioned front side view of the pin, the slotted nut and the bolt, in accordance with an embodiment of the present invention;

FIG. 19 illustrates a perspective left side view of an exemplary cap, in accordance with an embodiment of the present invention;

FIG. 20 illustrates a perspective right side view of the cap, in accordance with an embodiment of the present invention;

FIG. 21 illustrates a sectioned top view of the cap, in accordance with an embodiment of the present invention;

FIG. 22 illustrates a side sectioned side view of the cap, the section taken along section B-B of FIG. 21, detailing a threaded opening of an open end, in accordance with an embodiment of the present invention;

FIG. 23 illustrates a top view of the cap, in accordance with an embodiment of the present invention; and

FIG. 24 illustrates a top view of the cap, in accordance with an embodiment of the present invention.

Like reference numerals refer to like parts throughout the various views of the drawings.

### DETAILED DESCRIPTION OF THE INVENTION

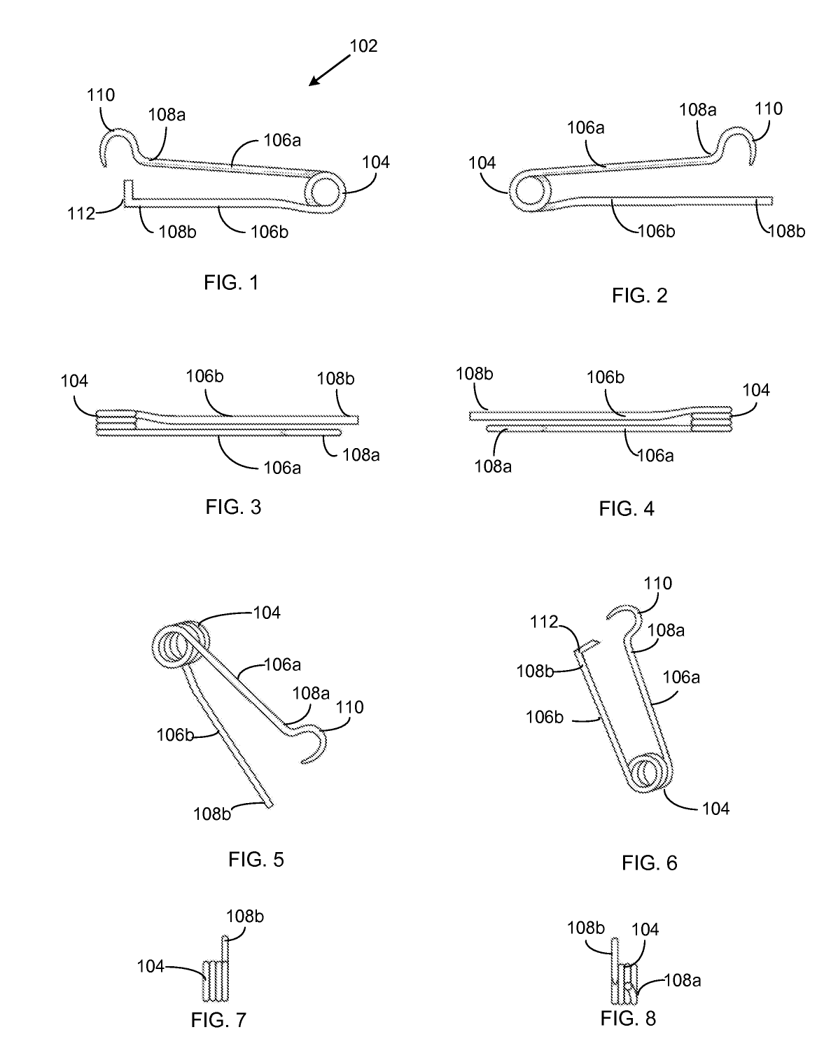

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

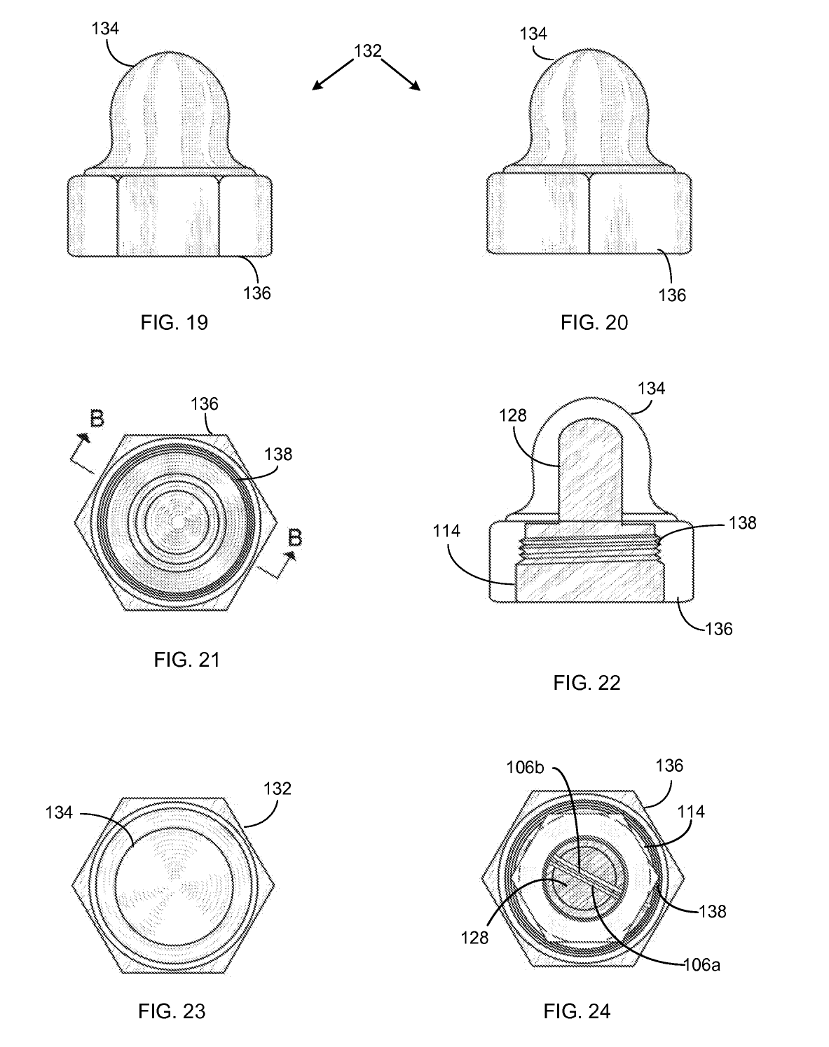

FIGS. 1-24 illustrate a torsional fastening assembly 100 for fastening a slotted nut 114 in a fixed position relative to a bolt 128. The torsional fastening assembly 100 comprises at least one of: a pin 102, a slotted nut 114, a bolt 128, and a cap 132. The pin 102 comprises a torsion spring 104, which leverages torque that is generated from the torsion spring 104 being wound. The pin 102 further comprises a pair of legs 106a, 106b having deviated free ends 108a, 108b to engage and fix the slotted nut 114 in a locked threaded position relative to the bolt 128. The legs 106a, 106b are pressed against the threaded region of the slotted nut 114 and the bolt 128 through the torsional force generated by the torsion spring 104.

In some embodiments, the torsional fastening assembly 100 may include a pin 102 that leverages torque from a torsion spring 104 and a pair of spaced apart legs 106a, 106b to fix a slotted nut 114 in a locked threaded position relative to the bolt 128. The torsional fastening assembly 100 leverages torsional force to lock the slotted nut 114 in a fixed threaded position relative to a bolt 128, such that the slotted nut 114 is restricted from rotation, and the pin 102 is restricted from disengaging from the slotted nut 114. The torsional fastening assembly 100 is fabricated form stainless steel to inhibit rust and corrosion. The torsional fastening assembly 100 may further utilizes a cap 132 to conceal the pin 102 and slotted nut 114, as described below.

As referenced in FIG. 1, the pin 102 includes a torsion spring 104 that diverges into a pair of legs 106a, 106b having free ends 108a, 108b. A first free end 108a includes a hump 110, while a second free end 108b includes a generally 90° bend 112. The torsion spring 104 exerts a torsional force on the pin 102 in an opposite direction in which the torsion spring 104 is wound. The torsional force biases the pair of legs 106a, 106b to diverge at the free ends 108a, 108b (FIGS. 2-4). This divergence of the legs 106a, 106b is essential to restricting rotation of a slotted nut 114 relative to a bolt 128, as discussed below. The spaced apart relationship of the legs 106a, 106b is illustrated in FIGS. 5-8. In one possible embodiment, the legs 106a, 106b may diverge from each other at about between 5° to 30°. However, those skilled in the art will recognize that the divergence of the legs 106a, 106b is dependent on the torsional force exerted by the torsion spring 104.

In some embodiments, the pin 102 may be fabricated from stainless steel, so as to exert greater torsion, enhance tensile and shear strength, and inhibit rust. This construct provides a significant tensile and shear strength, along with corrosion resistant. Those skilled in the art will recognize that a traditional cotter pin made of carbon steel is susceptible to rust and also does not have the same tensile and shear strength as the present pin 102. The pin 102 may also have different gauge thicknesses and operate in substantially the same manner.

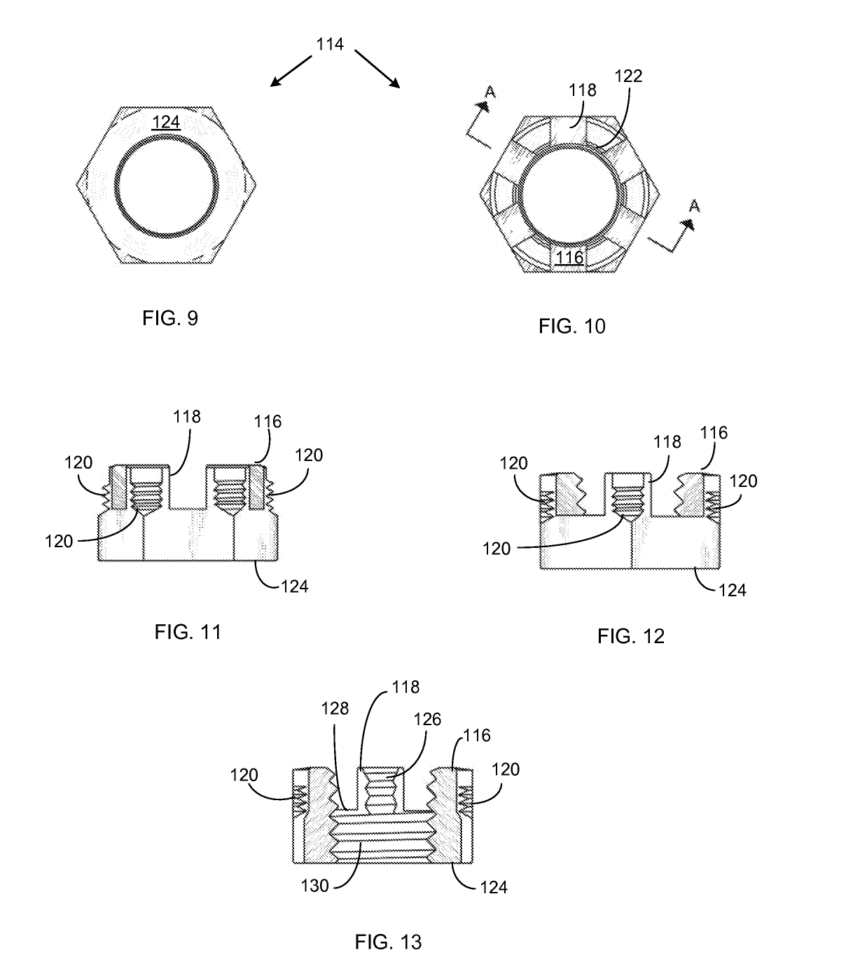

Turning now to FIGS. 9-12, the pin 102 may work in conjunction with a slotted nut 114 and a bolt 128 to prevent the slotted nut 114 from unthreading itself from the bolt 128. The slotted nut 114 is defined by a male end 116 having a plurality of slots 118. The slots 118 are configured to enable passage of the pin 102 through the spaces between the slots 118 for passing through a hole in the bolt 128. The slots 118 have a slot outer thread 120 and a slot inner thread 122. The slotted nut 114 is further defined by a female end 124 having a threaded inner surface 126. In some embodiments, the slotted nut 114 may include a castle nut or a slotted hex nut (FIG. 13). Suitable materials for the slotted nut 114 may include, without limitation, stainless steel and metal alloys.

Turning now to FIG. 14, the bolt 128 is defined by an outer threaded surface 130 that is configured to rotatably mate with the threaded inner surface 126 of the slotted nut 114 (See also FIG. 24). The bolt 128 further includes a hole that enables passage of the free legs 106a, 106b of the pin 102. The torsion spring 104 is larger than the hole, so as to restrict passage of the torsion spring 104 in a first direction. In some embodiments, the bolt 128 may include a hexagonal head having a slot for receiving a screwdriver, and an oppositely disposed tapered or threaded tip. Suitable materials for the bolt 128 may include, without limitation, stainless steel and metal alloys.

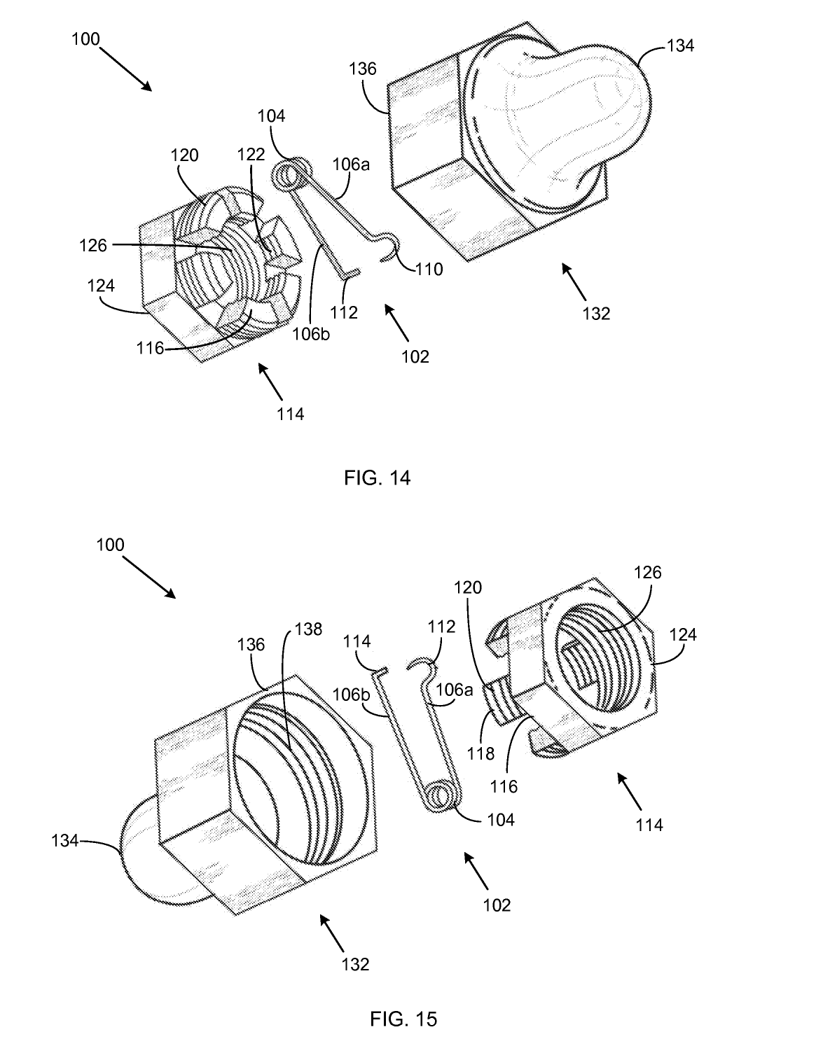

In operation, the bolt 128 is threaded through the slotted nut 114 to a desired threaded position. Once the desired threaded position has been achieved, the pair of free legs 106a, 106b from the pin 102 are pressed together and pass through the hole in the bolt 128 in a first direction. The first free end 108a having the hump 110 engages an outer threaded surface 130 of the bolt 128. The generally curved shape of the hump 110 partially wraps around the circumference of the outer threaded surface 130 of the bolt 128, helping to restrict rotation of the bolt 128 inside the slotted nut 114 (FIG. 15).

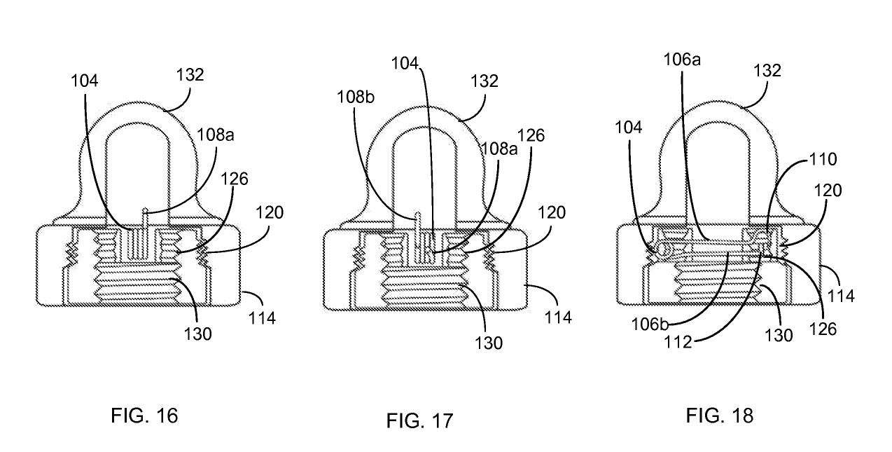

As illustrated in FIG. 16, the generally 90° bend 112 on the second free end 108b wedges between the outer threaded surface 130 of the bolt 128 and a threaded inner surface 126 of the slotted nut 114 to further restrict rotation of the slotted nut 114 relative to the bolt 128. The thickness of the second free end 108b may be tapered to create a better wedging effect. The torsion generated by the torsion spring 104 is what presses the hump 110 and the generally 90° bend 112 on the free ends of the legs 106a, 106b against the respective threads of the slotted nut 114 and the bolt 128.

Should the pin 102 begin to disengage towards the torsion spring 104 and the hump 110 begins to enter the hole in the bolt 128, the end of the generally 90° bend 112 wedges between the outer threaded surface 130 of the bolt 128 and the threaded inner surface 126 of the slotted nut 114; thereby creating a jam. The slotted nut cannot continue to unthread since the generally 90° bend 112 is engaged in the threaded area of the slotted nut 114 and bolt 128.

In this manner, the hump 110 and the generally 90° bend 112 are engaged around the slotted nut 114 and the bolt 128, such that they cannot pass through the hole in a second direction (FIG. 17). Thus, the pin 102 has three points for preventing the pin 102 from disengaging from the slotted nut 114 and the bolt 128. The three points are: the torsion spring 104, the hump 110, and the generally 90° bend 112. These points of contact are illustrated in FIG. 18.

Once fully engaged, the pin 102 is disposed within a perimeter of the slotted nut 114. A cap 132 is configured to at least partially conceal the free ends 108a, 108b of the pin 102 and the slotted nut 114. The cap 132 is defined by a closed end 134 and an open end 136 having a threaded opening 138. The threaded opening 138 of the cap 132 rotatably mates with the slot outer thread 120 of the slotted nut 114. In this manner, both the free ends of the pin 102 and the slotted nut 114 may be concealed. In one embodiment, the closed end 134 of the cap 132 is rounded and the open end 136 of the cap 132 is hexagonal. Though, in other embodiments, additional shapes for the cap 132 may be used. Thus, because the cap 132 covers the pin 102 and the slotted nut 114, the torsion fastening assembly 100 is aesthetically pleasing since it confines itself to the outer diameter of the slotted nut 114, without displaying protruding free ends. The capacity to conceal free ends 108a, 108b may be especially beneficial in the automotive industry, where myriad automotive components utilize threaded bolts and accompanying nuts.

These and other advantages of the invention will be further understood and appreciated by those skilled in the art by reference to the following written specification, claims and appended drawings.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A torsional fastening assembly, the assembly comprising:
a pin, the pin defined by a torsion spring, the torsion spring configured to exert a torsional force in an opposite direction in which the torsion spring is wound, the pin further defined by a pair of spaced apart legs terminating at a first free end and a second free end, the first free end having a hump, the second free end having a generally 90 degree bend,
wherein the torsional force biases the pair of legs to diverge at the free ends.

2. The assembly of claim 1, wherein the pin is fabricated from stainless steel.

3. The assembly of claim 1, wherein the pin is configured to be fabricated from different gauge thicknesses.

4. A torsional fastening assembly, the assembly comprising:
a pin, the pin defined by a torsion spring, the torsion spring configured to exert a torsional force in an opposite direction in which the torsion spring is wound, the pin further defined by a pair of spaced apart legs terminating at a first free end and a second free end, the first free end having a hump, the second free end having a generally 90 degree bend,
wherein the torsional force biases the pair of legs to diverge at the free ends;
a slotted nut, the slotted nut defined by a male end having a plurality of slots, the plurality of slots configured to enable passage of the pair of spaced apart legs across the diameter of the slotted nut, the plurality of slots further configured to restrict passage of the torsion spring across the plurality of slots in a first direction, the plurality of slots further configured to restrict passage of the first free end and the second free end across the plurality of slots in a second direction, the slotted nut further defined by a female end, the female end having a threaded inner surface; and
a bolt, the bolt defined by an outer threaded surface, the bolt configured to rotatably pass through the slotted nut,
wherein the outer threaded surface of the bolt rotatably engages the threaded inner surface of the slotted nut for enabling the rotatable passage of the bolt through the slotted nut,
wherein the hump at least partially wraps around the threaded outer surface of the bolt to help restrict rotation of the bolt through the slotted nut,
wherein the generally 90 degree bend wedges between the outer threaded surface of the bolt rotatably and the threaded inner surface of the slotted nut to help restrict rotation of the bolt through the slotted nut.

5. The assembly of claim 4, wherein the pin is fabricated from stainless steel.

6. The assembly of claim 4, wherein the pin is configured to be fabricated from different gauge thicknesses.

7. The assembly of claim 4, wherein the slotted nut is a castle nut or a slotted hex nut.

8. The assembly of claim 4, wherein the torsional force is operational to engage the hump and the generally 90 degree bend against the slotted nut and the bolt.

9. The assembly of claim 4, wherein the bolt comprises a hole.

10. The assembly of claim 9, wherein the hole is configured to enable passage of the pair of spaced apart legs.

11. The assembly of claim 10, wherein the hole has a smaller diameter smaller than the torsion spring.

12. A torsional fastening assembly, the assembly comprising:
a pin, the pin defined by a torsion spring, the torsion spring configured to exert a torsional force in an opposite direction in which the torsion spring is wound, the pin further defined by a pair of spaced apart legs terminating at a first free end and a second free end, the first free end having a hump, the second free end having a generally 90 degree bend,
wherein the torsional force biases the pair of legs to diverge at the free ends;
a slotted nut, the slotted nut defined by a male end having a plurality of slots, the plurality of slots configured to enable passage of the pair of spaced apart legs across the diameter of the slotted nut, the plurality of slots further configured to restrict passage of the torsion spring across the plurality of slots in a first direction, the plurality of slots further configured to restrict passage of the first free end and the second free end across the plurality of slots in a second direction, the slotted nut further defined by a female end, the female end having a threaded inner surface;
a bolt, the bolt defined by an outer threaded surface, the bolt configured to rotatably pass through the slotted nut,
wherein the outer threaded surface of the bolt rotatably engages the threaded inner surface of the slotted nut for enabling the rotatable passage of the bolt through the slotted nut,
wherein the hump at least partially wraps around the threaded outer surface of the bolt to help restrict rotation of the bolt through the slotted nut,
wherein the generally 90 degree bend wedges between the outer threaded surface of the bolt rotatably and the threaded inner surface of the slotted nut to help restrict rotation of the bolt through the slotted nut; and
a cap, the cap defined by a closed end and an open end having a threaded opening, the cap configured to at least partially cover the pin and the slotted nut.

13. The assembly of claim 12, wherein the pin is fabricated from stainless steel.

14. The assembly of claim 12, wherein the pin is configured to be fabricated from different gauge thicknesses.

15. The assembly of claim 12, wherein the torsional force is operational to engage the hump and the generally 90 degree bend against the slotted nut and the bolt.

16. The assembly of claim 12, wherein the closed end of the cap is round.

17. The assembly of claim 12, wherein the open end of the cap is hexagonal.

18. The assembly of claim 12, wherein the bolt comprises a hole.

19. The assembly of claim 18, wherein the hole is configured to enable passage of the pair of spaced apart legs.

20. The assembly of claim 19, wherein the hole is smaller than the torsion spring.
